(19) United States
(12) Patent Application Publication
(10) Pub. No.: US 2004/0062553 A1
(43) Pub. Date: Apr. 1, 2004

(54) Bidirectional optical link

(76) Inventor: Daniel N. Harres, Belleville, IL (US)

Correspondence Address: DAVID J. CLEMENT, THE BOEING COMPANY, PO BOX 516, ST. LOUIS, MO, 63166-0516, US

(21) Appl. No.: 10/255,820

(22) Filed: Sep. 26, 2002

(51) Int. Cl. H04B 10/00; H04B 10/12

(52) U.S. Cl. 398/168; 398/108; 398/128

(57) ABSTRACT

A bidirectional optical link for communication between a first data unit and a second data unit using a single optical source. In a broad aspect it includes a modulator/optical receiver system that includes a splitter element; a receiver element and a return modulator. The splitter element receives an incoming modulated optical signal from an optical source associated with a first data unit. It splits the incoming optical signal into a received optical portion and an outgoing optical portion. The receiver element detects the received optical portion and converts the received optical portion to an electrical signal to be communicated to a second data unit. The return modulator element modulates the outgoing optical portion and transmits the modulated outgoing optical portion to the first data unit. The modulation of the outgoing optical portion allows the use of a single, shared optical source.

### BACKGROUND OF THE INVENTION

1. Field of the Invention

The present invention relates to bidirectional optical links and more particularly to a free-space bidirectional optical link that uses a single, shared optical source.

2. Description of the Related Art

A number of situations exist where communication from aircraft to a ground terminal or ground terminal to an overhead aircraft is needed. Doing this with RF transceivers has several associated problems. The data rate of RF transceivers is limited to, at most, a few tens of MHz, and for many applications, far less. In addition, the signal can be intercepted fairly easily. Encryption can solve this second problem, but encryption degrades the information rate and does not remove the energy of the signal—so the existence of the RF source can still be detected, even if the information is not decodable.

Free-space optical communications is being developed by a number of programs as an alternative to RF. Doing this in an inexpensive fashion is a challenge and the invention disclosed herein describes a way in which full-duplex communication can be achieved with only a single laser.

U.S. Pat. No. 4,941,205, issued to Horst et al, discloses, a system and method for optically communicating data simultaneously between two data handling units where one of the data units supplies all of the optical power needed for the optical communications between the two data units. In a preferred embodiment a first data unit comprises a first data source, first and second optical sources of optical energy, and a first optical detector, while a second data unit comprises a second data source, a second optical detector and an optical modulator. In a first mode of operation, a first stream of digital data from the first data source pulse modulates the first optical source on and off causing the first optical source to transmit optical pulses to the second optical detector. These optical pulses are converted by the second optical detector back into a representation of the first stream of digital data for use by the second data unit. In a second mode of operation unmodulated optical energy is transmitted from the second optical source in the first data unit to the optical modulator in the second data unit. A second stream of digital data from the second data source is applied to the optical modulator to accordingly modulate the received unmodulated optical energy. Modulated optical pulses from the optical modulator are therefore reflected to the first optical detector. These reflected modulated optical pulses are converted by the first optical detector back into a representation of the second stream of digital data for use by the first data unit. The system requires the use of a second optical source within the first data unit to be used for communications from the second data unit back to the first data unit.

U.S. Pat. No. 5,600,471, issued to Hirohashi, et al., discloses an optical wireless transmission system providing short-distance communication, such as for linking a personal computer to a LAN, utilizes direct baseband modulation of optical signals, but provides simultaneous bidirectional transmission of data between a pair of optical transmitting/receiving units while also enabling a data clock signal to be easily regenerated from a received optical signal. Effects of signal noise due to artificial illumination are eliminated by a suitable choice of transmission bandwidth, and bandpass filtering of a received data signal. This system locates the optical source associated with the first data unit within the first data unit and the optical source associated with the second data unit within the second data unit. So it also requires the use of two separate optical sources (one for each direction of data) and it is also set up in the conventional way (that is, optical source co-located with data source).

U.S. Pat. No. 6,122,084, issued to Britz, et al, a free-space optical communications system and method in which a transmitter transmits a free-space optical communication beam to an optical receiver. The receiver includes an optical detector, an optical input level sensor and an optical attenuation device. The optical detector detects the optical communication beam, while the optical input level sensor senses an optical input level of the optical communication beam at the optical detector and outputs a control signal corresponding to the sensed optical input level. The optical attenuation device is responsive to the control signal by attenuating the optical input level of the optical communication beam to be less than a predetermined input level. The optical input level sensor includes a detector optical level sensor, a comparator circuit and a controller. The detector bias level sensor senses an optical level of the optical detector. The comparator circuit is coupled to the detector bias level sensor and compares the sensed optical level of the optical detector to predetermined threshold levels. The comparator circuit outputs a code signal relating a magnitude of the sensed optical level of the optical detector to the predetermined thresholds. The controller is responsive to the code signal by outputting the control signal. The '084 patent describes a single, one-way transmitter-receiver pair. Any full-duplex implementation employing the methods contained in that patent would require the use of two such systems, including two lasers.

U.S. Pat. No. 5,416,627, issued to Wilmoth, discloses a high-speed two-way optical data link that has both light-emitting and light-sensing units mounted adjacent one another in a single housing together with a timing and control unit providing all signals necessary for simultaneous transmission and reception of dam. Synchronization to a clock signal is achieved by use of edge detectors which reset the counters to zero in the timing and control unit whenever a transition in data pulses is sensed. A pair of computers are linked using a program called “Crosstalk” which performs full parity checking of all data received by an associated computer. The data link permits the computers to be “live handshaking” and asynchronous at all times. Another embodiment comprises a strip array which eliminates the optical bulkiness of a parabolic reflector. The strip array also provides a better collection of infrared light since the photodetectors are spread over a larger area than previously allowed with a parabolic reflector. A further embodiment comprises a hemispherical array for communication throughout a room including an ovate or spheroid configuration. The optical data link disclosed in this patent, like the prior art discussed above, requires the use of separate sources for each direction of data communication.

U.S. Pat. No. 6,118,567, issued to Alameh, et al., discloses waveform encoding method and device that provides for generating/receiving a power efficient binary intensity modulated optical data signal from a binary source signal which minimizes a time between adjacent pulse transitions and maximizes a pulse peak amplitude for transmission over a low-power wireless infrared link. In generating the signal, the method includes: generating a Q-ary pulse position modulation, Q-PPM, encoded data signal from binary data where Q represents 2^{L} time slots and L is a predetermined integer representing a predetermined number of binary source bits of the power efficient binary intensity modulated optical data signal; generating an efficient binary intensity modulated signal by increasing the pulse peak amplitude of the Q-PPM encoded data signal by a factor of k, k a predetermined value, and decreasing a pulse width of the Q-PPM encoded data signal by k; and transmitting the efficient binary intensity modulated signal over the low-power wireless infrared link. This device also uses separate light sources for each direction.

### SUMMARY

The present invention is a bidirectional optical link for communication between a first data unit and a second data unit using a single optical source. In a broad aspect it includes a modulator/optical receiver system that includes a splitter element; a receiver element and a return modulator. The splitter element receives an incoming modulated optical signal from an optical source associated with a first data unit. It splits the incoming optical signal into a received optical portion and an outgoing optical portion. The receiver element detects the received optical portion and converts the received optical portion to an electrical signal to be communicated to a second data unit. The return modulator element modulates the outgoing optical portion and transmits the modulated outgoing optical portion to the first data unit. The modulation of the outgoing optical portion allows the use of a single, shared optical source.

The bidirectional communication described herein between first and second data units can take place simultaneously, allowing for full-duplex operation using this single laser source located in the first data unit.

Other objects, advantages, and novel features will become apparent from the following detailed description of the invention when considered in conjunction with the accompanying drawings.

### BRIEF DESCRIPTION OF THE DRAWINGS

FIG. 1 is a schematic illustration of a preferred embodiment of the bidirectional optical link of the present invention.

FIG. 2 is an illustration of waveforms showing data unit to data unit patterns using Manchester modulation in both directions.

FIG. 3 is an illustration of waveforms showing Manchester modulation in one direction and OOK modulation in the other direction.

FIG. 4 is a schematic illustration showing implementation of the present invention as between an aircraft and a ground terminal having a modulator/optical receiver without an optical source.

The same parts or elements throughout the drawings are designated by the same reference characters.

### DETAILED DESCRIPTION OF THE INVENTION

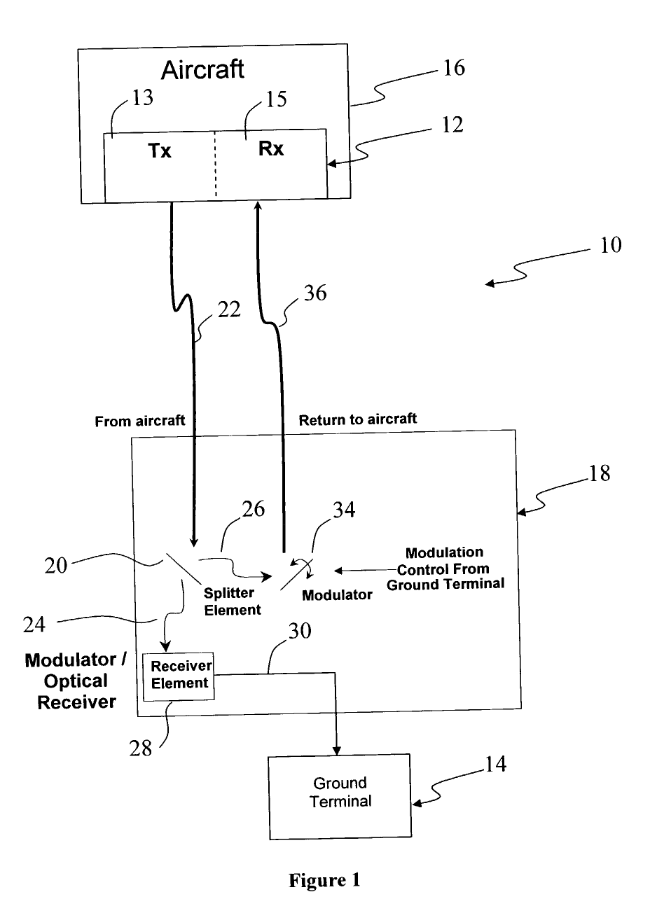

Referring to the drawings and the characters of reference marked thereon FIG. 1 is a preferred embodiment of the bidirectional optical link of the present invention, designated generally as 10. The bidirectional optical link 10 provides communication between a first data unit 12 and a second data unit 14. Typically, the first data unit 12 may be, for example, a transmit/receive unit associated with an aircraft 16. The transmit/receive unit 12 includes a transmitter 13 and a receiver 15. The first data unit 12 has a data processing unit that supplies the data to the transmitter 13 and makes use of the data at the receiver 15. The second data unit 14 may be, for example, a ground terminal 14. Although this bidirectional optical link 10 is particularly useful with aircraft applications it may be used in a variety of environments such as between satellites in space, between office buildings and other terrestrial free-space optical communications systems, and in fiber optic systems.

The bidirectional optical link 10 includes a modulator/optical receiver system, designated generally as 18. The modulator/optical receiver system 18 includes a splitter element 20 for receiving an incoming modulated optical signal 22 from an optical source associated with the first data unit 12. The optical source may be, for example, a laser, an LED, or other suitable optical sources. The splitter element 20 splits the incoming optical signal 22 into a received optical portion 24 and an outgoing optical portion 26. The splitter element 20 is a device which transmits the light through two separate paths. It may be, for example, a device that transmits a portion of the light through one path and reflects a portion of the light to another path. Or, in other embodiments, the splitter consists of a glass fiber which literally splits into two fibers, accepting incoming light in the single fiber and distributing it between the two exiting fibers.

A receiver element 28 detects the received optical portion 24 and converts the received optical portion to an electrical signal 30 to be communicated to the second data unit 14.

The first data unit 12 includes an originating modulator element for producing the incoming modulated optical signal 22. The originating modulator element may, for example, provide direct modulation of the optical source or be an external modulator. A number of external modulators presently exist and are used for optical communications. These modulators modify the index of refraction, the polarization, the direction of the flow, or some other property of the incoming light in such a way that light is transmitted or not transmitted. The control of this transmission property is generally electronic, consisting of an electric potential across or an electrical current through the device. Examples of the “direction of flow” devices include a number of microelectromechanical system (MEMS) devices available from JDS Uniphase (for example, the MOM series switch) as well as other companies. An example of an index-of-refraction modulator is the Lithium Niobate Interferometric switch from JDS Uniphase. The Lithium Niobate Component Polarization Controller from JDS Uniphase is an example of a polarization-type of modulator.

A return modulator element 34 modulates the outgoing optical portion and transmits the modulated outgoing optical portion 36 to the first data unit 12. The return modulator element 34 can be any of the devices described for the external modulator in the first data unit 12. Note that FIG. 1 shows schematically a movable mirror (for example, a MEMS reflector), which is a device that controls the direction of the flow of the light, but other external modulators, such as those controlling the index of refraction, the polarization, or other optical property could be employed to perform the modulation.

The return modulator element 34 and the originating modulator element preferably utilize Manchester modulation. Manchester modulation is well known in this field. Preferably, the originating modulator element 32 modulates at a rate of R and the return modulator element 34 modulates at a maximum rate of R/2. Other modulation rates may be used; however, the return modulator element should modulate at a rate that is a sub-multiple of R/2. Other suitable modulation schemes could be used besides Manchester, such as on-off keying (OOK) modulation.

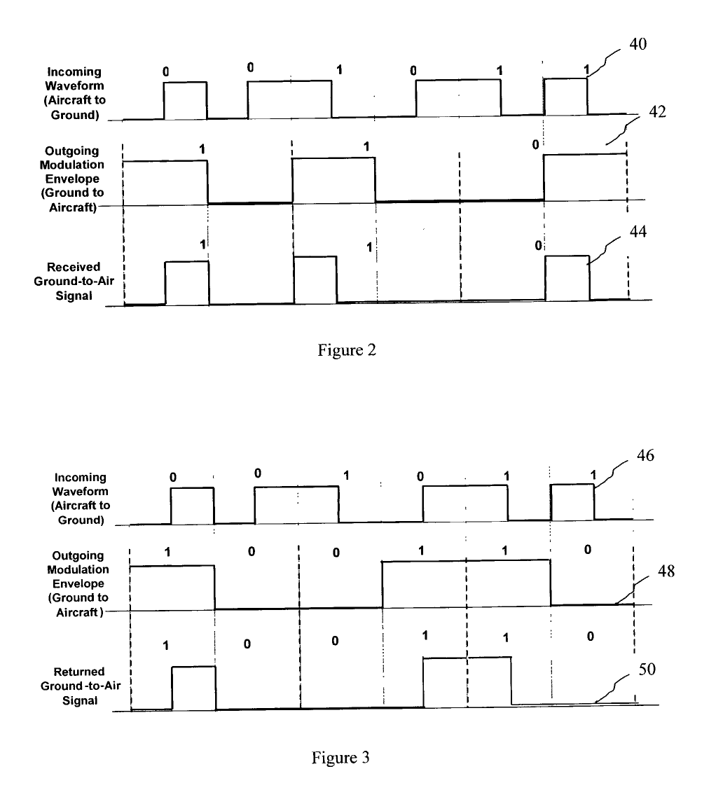

Referring now to FIG. 2, the waveforms for a random sequence of incoming and outgoing bits are illustrated, designated respectively as 40 and 42. The modulated outgoing optical portion 36 is phase synchronous with the incoming modulated optical signal. This is not difficult to achieve since phase synchronization is required at the second data unit, e.g. ground terminal, in order to demodulate the incoming bitstream. The modulation envelope 44 is generated at the second data unit and is multiplied by the incoming bit sequence 40 to produce the outgoing bit sequence 42.

When the outgoing data is a Manchester ‘1’, it contains a pulse either in the first quarter of the second quarter of the outgoing bitstream and no light in the second half of the bitstream. On the other hand, a Manchester ‘0’ contains no light in the first half of the bitstream and a pulse of light either in the third quarter or the fourth quarter of the bitstream.

Thus, there are two representations for a logic ‘1’ received back at the aircraft and two possible representations for a logic ‘0’ received. At the first data unit, e.g. aircraft, the frequency is already known (since the original waveform was generated at the aircraft) and it is only phase synchronization that is required. A variable phase delay and a state machine that assigns each incoming waveform (with one of four possible shapes) to each of two logic states is all that is needed to demodulate and decode the ground-to-air received waveform.

Referring now to FIG. 3, waveforms representing an example in which there is Manchester-encoded incoming data and outgoing OOK-encoded data. The Manchester-encoded data 46 comes in at data rate, R. The OOK modulation envelope 48 (that is, the control signal that determines whether the incoming light is returned to the originating system or not) is the second waveform and corresponds to “return the signal” when a data ‘1’ is to be sent and corresponds to “don't return the signal” when a data ‘0’ is to be sent. The modulator remains in this one or the other state the entire bit period with OOK modulation.

The actual returned signal 50 is therefore just the incoming signal, unmodified, when the signal is supposed to be a ‘1’ and no signal when the data is a ‘0’ (the third waveform). We can state the rule for return signal as either light in the first half or second half of the bit when data ‘1’ is being transmitted and no light in either half of the bit when a data ‘0’ is being transmitted. The maximum rate for the OOK return signal is R.

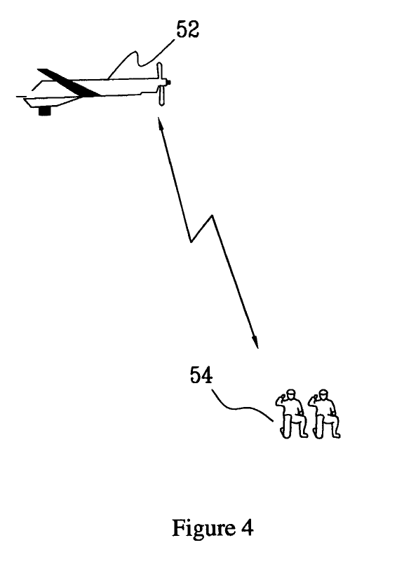

FIG. 4 shows an embodiment of the system described herein as implemented with an aircraft 52 and a ground terminal 54. The overhead aircraft contains the first data unit and therefore contains the only laser. Soldiers on the ground communicate with this aircraft data unit through a second data unit associated with the ground terminal 54 that has a modulator/optical receiver, e.g. electromechanical reflecting device, associated with it but no optical source.

The present invention can have many applications in addition to that discussed above. For example, it may be used for interoffice communications, indoor free-space local area networks, and, free-space optical communications between ground forces.

Obviously, many modifications and variations of the present invention are possible in light of the above teachings. It is, therefore, to be understood that within the scope of the appended claims, the invention may be practiced otherwise than as specifically described.

What is claimed and desired to be secured by Letters Patent of the United States is:

1. A bidirectional optical link for communication between a first data unit and a second data unit using a single optical source, comprising:
a modulator/optical receiver system, comprising:
a) a splitter element for receiving an incoming modulated optical signal from an optical source associated with a first data unit and splitting said incoming optical signal into a received optical portion and an outgoing optical portion;
b) a receiver element for detecting said received optical portion and for converting said received optical portion to an electrical signal to be communicated to a second data unit; and,
c) a return modulator element for modulating said outgoing optical portion and transmitting the modulated outgoing optical portion to the first data unit, wherein,
the modulation of the outgoing optical portion allows the use of a single, shared optical source.

2. The bidirectional optical link of claim 1, wherein said return modulator element utilizes Manchester modulation.

3. The bidirectional optical link of claim 1, further including an originating modulator element for producing said incoming modulated optical signal, said modulated outgoing optical portion being phase synchronous with said incoming modulated optical signal.

4. The bidirectional optical link of claim 3, wherein said return modulator element and said originating modulator element utilize Manchester modulation.

5. The bidirectional optical link of claim 4, wherein said originating modulator element modulates at a rate of R and said return modulator element modulates at a maximum rate of R/2.

6. The bidirectional optical link of claim 4, wherein said originating modulator element modulates at a rate of R and said return modulator element modulates at a rate that is a sub-multiple of R/2.

7. The bidirectional optical link of claim 1, wherein said return modulator element utilizes on-off keying (OOK) modulation.

8. The bidirectional optical link of claim 3, wherein said return modulator element utilizes on-off keying (OOK) modulation and said originating modulator element utilizes Manchester modulation.

9. The bidirectional optical link of claim 8, wherein said originating modulator element modulates at a rate of R and said return modulator element modulates at a maximum rate of R.

10. The bidirectional optical link of claim 1, wherein said optical source comprises a laser.

11. The bidirectional optical link of claim 1, wherein said optical source comprises an LED.

12. The bidirectional optical link of claim 1, wherein said first data unit comprises a transmit/receive unit of an aircraft.

13. The bidirectional optical link of claim 1, wherein said second data unit comprises a ground terminal for aircraft.

14. A bidirectional optical communication system, comprising:
a) a first data unit comprising an optical source and an originating modulator element;
b) a second data unit;
c) a modulator/optical receiver system, comprising:
i) a splitter element for receiving an incoming modulated optical signal from said optical source and splitting said incoming optical signal into a received optical portion and an outgoing optical portion;
ii) a receiver element for detecting said received optical portion and for converting said received optical portion to an electrical signal to be communicated to said second data unit; and,
iii) a return modulator element for modulating said outgoing optical portion and transmitting the modulated outgoing optical portion to the first data unit, wherein,
the modulation of the outgoing optical portion allows the use of such a single, shared optical source.

15. The bidirectional optical link of claim 14, wherein said return modulator element utilizes Manchester modulation.

16. The bidirectional optical link of claim 14, further including an originating modulator element for producing said incoming modulated optical signal, said modulated outgoing optical portion being phase synchronous with said incoming modulated optical signal.

17. The bidirectional optical link of claim 16, wherein said return modulator element and said originating modulator element utilize Manchester modulation.

18. The bidirectional optical link of claim 17, wherein said originating modulator element modulates at a rate of R and said return modulator element modulates at a maximum rate of R/2.

19. The bidirectional optical link of claim 17, wherein said originating modulator element modulates at a rate of R and said return modulator element modulates at a rate that is a sub-multiple of R/2.

20. The bidirectional optical link of claim 14, wherein said return modulator element utilizes on-off keying (OOK) modulation.

21. The bidirectional optical link of claim 17, wherein said return modulator element utilizes on-off keying (OOK) modulation and said originating modulator element utilizes Manchester modulation.

22. The bidirectional optical link of claim 21, wherein said originating modulator element modulates at a rate of R and said return modulator element modulates at a maximum rate of R.

23. The bidirectional optical link of claim 14, wherein said optical source comprises a laser.

24. The bidirectional optical link of claim 14, wherein said optical source comprises an LED.

25. The bidirectional optical link of claim 14, wherein said first data unit comprises a transmit/receive unit of an aircraft.

26. The bidirectional optical link of claim 14, wherein said second data unit comprises a ground terminal for aircraft.

27. A method for communicating between a first data unit and a second data unit using a single optical source, comprising the steps of:
a) splitting an incoming modulated optical signal into a received optical portion and an outgoing optical portion;
b) detecting said received optical portion and converting said received optical portion to an electrical signal to be communicated to a second data unit; and,
c) modulating said outgoing optical portion and transmitting the modulated outgoing optical portion to the first data unit, wherein,
the modulation of the outgoing optical portion allows the use of a single, shared optical source.

28. The method of claim 27, wherein said return modulator element utilizes Manchester modulation.
